(19) United States
(12) Patent Application Publication
(10) Pub. No.: US 2020/0142569 A1
(43) Pub. Date: May 7, 2020

(54) ELECTRONIC APPARATUS AND METHOD OF FREEZING SCREEN

(71) Applicant: AVer Information Inc., New Taipei City (TW)

(72) Inventor: Po-Hsun WU, New Taipei City (TW)

(21) Appl. No.: 16/538,850

(22) Filed: Aug. 13, 2019

(30) Foreign Application Priority Data
Nov. 7, 2018 (TW) 107139550

(51) Int. Cl. G06F 3/0484; G06F 3/0481

(52) U.S. Cl. CPC G06F 3/04845; G06F 3/0481

(57) ABSTRACT

A method of freezing a screen includes the following operations: stop updating content of a bottom layer of a plurality of layers of an image shown on a screen in response to a first command; and displaying a content of a predetermined layer of the plurality of layers on the image.

### CROSS-REFERENCE TO RELATED APPLICATION

This application claims priority to Taiwan Application Serial Number 107139550, filed Nov. 7, 2018, which is herein incorporated by reference in its entirety.

### BACKGROUND

### Technical Field

The present disclosure relates to an electronic apparatus and a method of freezing screen. More particularly, the present disclosure relates to an electronic apparatus and a method of freezing screen applied to a plurality of layers.

### Description of Related Art

With the development of technology, electronic devices with interactive functions are often used in teaching, conferences, presentations, etc. For example, an electronic whiteboard can be used to illustrate related information by a user to play a video or perform writing, etc. In some cases, the user may need to teach or comment on a content of an image presented at a certain moment of the video. However, in current approaches, the user must first capture the image displayed on a certain moment of the image shown on the screen (At this moment, the captured image will contain unnecessary window content), and then open the captured image in a corresponding application to teach or explain, resulting in inconvenience to the user.

### SUMMARY

An aspect of the present disclosure relates to an electronic apparatus, comprising: a screen a memory and a processor. A screen configured to display an image, wherein the image comprises a plurality of layers; a memory configured to store at least one computer program code; a processor configured to execute at least one computer program code to perform the following operations: in response to a first instruction, control the screen to show content of a predetermined layer between a top layer and a bottom layer of the plurality of layers on the image.

An aspect of the present disclosure relates to a method of freezing a screen, comprising: in response to a first instruction, stop updating the content of a bottom layer of a plurality of layers of an image; and displaying content of a predetermined layer of the plurality of layers on the image.

In summary, through the electronic apparatus and the method of freezing screen in the above embodiments, the content of the specified layer can be efficiently extracted to improve user convenience and experience.

### BRIEF DESCRIPTION OF THE DRAWINGS

FIG. 1 shows a schematic diagram of an electronic apparatus according to an embodiment of the present disclosure.

FIG. 2A shows a schematic diagram of image displayed on the screen of

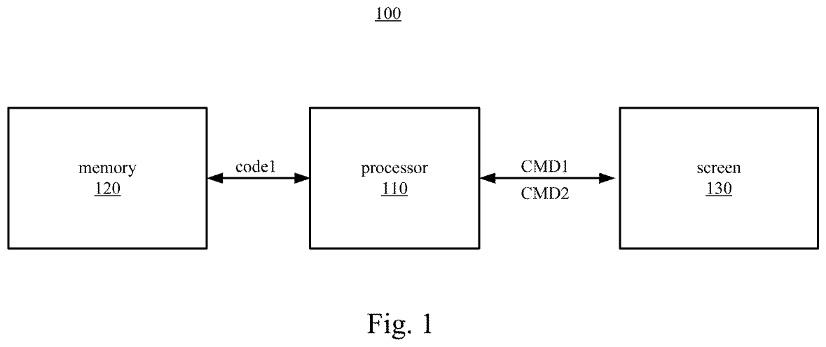

FIG. 1 according to an embodiment of the present disclosure.

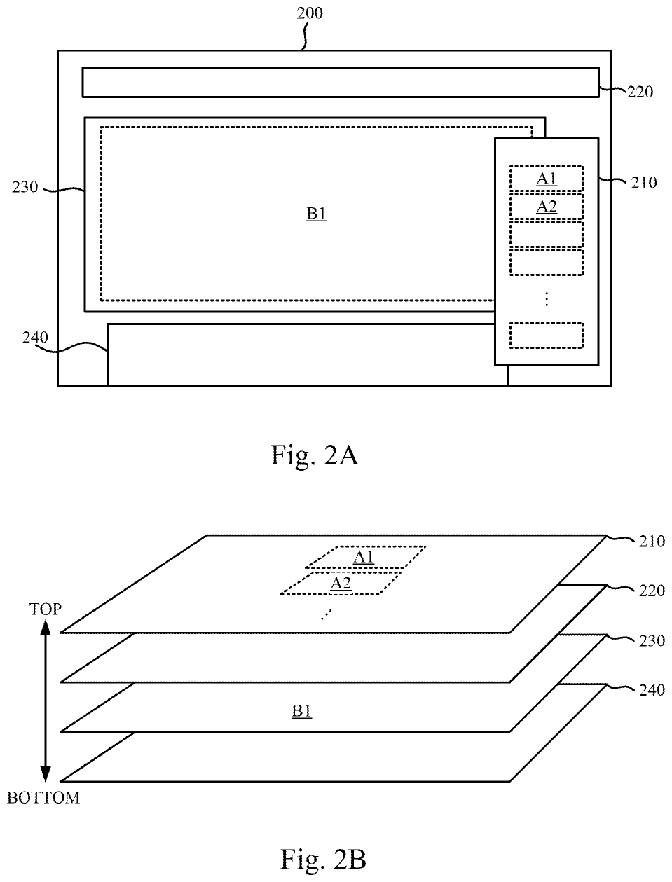

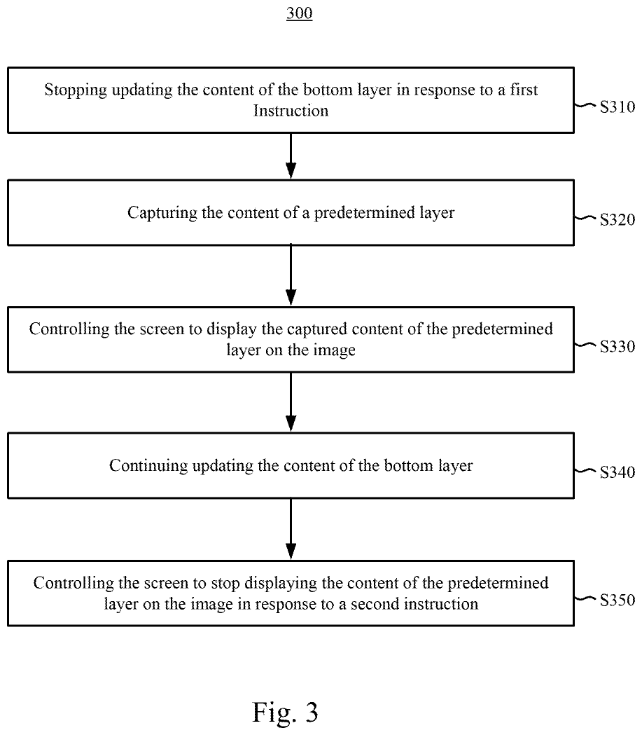

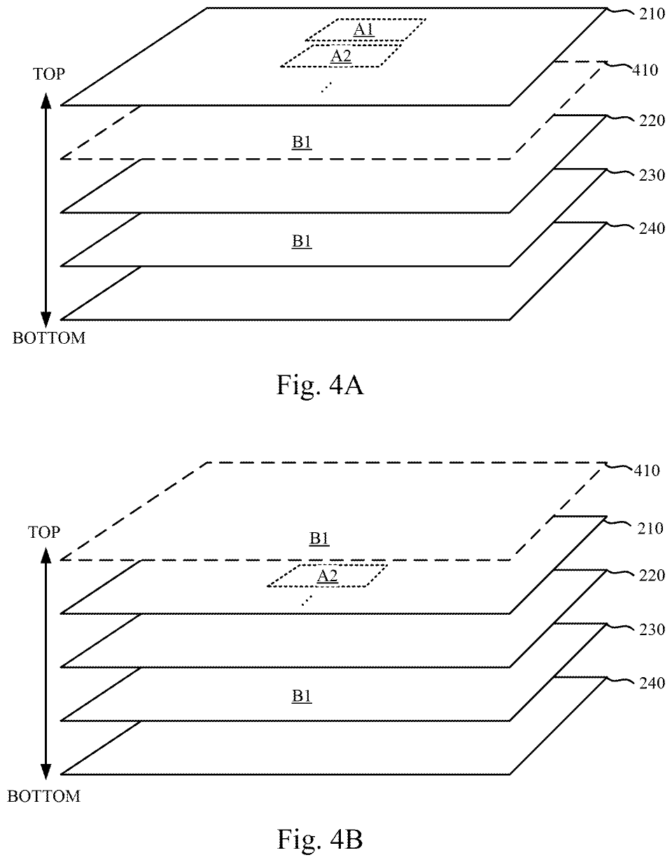

FIG. 2B shows a schematic diagram illustrating a hierarchy of the plurality of layers of FIG. 2A according to an embodiment of the present disclosure.

FIG. 3 shows a flow chart of a method of freezing screen in accordance with an embodiment of the present disclosure.

FIG. 4A shows a schematic diagram showing the hierarchy of the plurality of layers after operation is performed in accordance with an embodiment of the present disclosure.

FIG. 4B shows a schematic diagram showing the hierarchy of the plurality of layers after operation is performed in accordance with an embodiment of the present disclosure.

### DETAILED DESCRIPTION

The terms used in this specification generally have their ordinary meanings in the art. The use of examples anywhere in this specification including examples of any terms discussed herein is illustrative only, and in no way limits the scope and meaning of the disclosure or of any exemplified term. Likewise, the disclosure is not limited to various embodiments given in this specification.

It will be understood that when an element is referred to as being “connected” or “coupled” to another element. It can mean that two or more components are directly in physical or electrical contact with each other or indirect in physical or electrical contact with each other, it may also mean that two or more components operate or interact with each other.

Referring to FIG. 1, which is a schematic diagram of an electronic apparatus 100 according to some embodiments of the present disclosure. In different applications (which include, for example but not limited to, teaching, conferences, presentations, etc.), the electronic apparatus 100 may be, but not limited to, personal computer, tablet computer, mobile phone, note book, touch pad and/or E-board.

The electronic apparatus 100 includes a processor 110, a memory 120, and a screen 130. The processor 110 is coupled to the memory 120 and the screen 130. In some embodiments, the processor 110 is, but not limited to, a central processing unit (CPU), an application-specific integrated circuit (ASIC), a multiprocessor, a distributed processing system, or a suitable processing unit.

The memory 120 stores at least one computer program code code1 which is for implementing an application software of the electronic apparatus 100. For example, the memory 120 stores one or more code, which is for providing functions of the electronic apparatus 100 (e.g., video playback, web browsing, teaching applications, etc.). In some embodiments, the computer program code code1 can be encoded by a plurality of instruction sets to perform a plurality of operations including operations in FIG. 3 below. In this way, the processor 110 can execute at least one computer program code code1, and automatically execute multiple capturing operations on a specific layer (as described in FIG. 3 below).

In some embodiments, memory 120 is a non-transitory computer readable medium. In some embodiments, the computer readable storage medium is an electrical, magnetic, optical, infrared, and/or semiconductor system (or apparatus or device). For example, the computer readable storage medium includes semiconductor or solid state memory, magnetic tape, removable computer diskettes, random access memory (RAM), read only memory (ROM), hard disk, and/or optical disc. In some embodiments where the optical disc is employed, the computer readable storage medium includes compact disc read-only memory (CD-ROM), compact disc rewritable (CD-R/W) and/or digital versatile disc (DVD).

The screen 130 displays an image based on the control of the processor 110, in which the image may include a plurality of layers, and the layers may be used to display different content (e.g., application, graphical user interface (GUI), system status column, work column, etc.). In some embodiments, the electronic apparatus 100 may further include a video card (not shown) or a video processing circuit (not shown). The above circuits are able to provide processed image data to the screen for subsequent display based on the control of the processor 110.

In some embodiments, the screen 130 may be a touch screen that can be controlled by a user. The user can input a command CMD1 or CMD2 through the screen 130. The processor 110 may perform related operations (e.g., operations in FIG. 3 below) according to the command CMD1 or CMD2.

In some embodiments, the electronic apparatus 100 can also cooperate with other input/output devices (not shown) to receive the aforementioned command CMD1 or CMD2. In some embodiments, the input/output device includes a keyboard, a numeric keypad, a mouse, a trackball, a cursor direction key, a remote controller, a tablet, a touch input device, or a combination thereof to communicate information and a plurality of commands to the processor 110. The above ways of inputting the command CMD1 or CMD2 are given for illustrative purposes. Various ways of inputting the command CMD1 or CMD2 are within the contemplated scope of this case.

In order to facilitate the descriptions of method 300 of freezing screen of FIG. 3, various related words or elements will be described with reference to FIGS. 2A to 2B in sequence.

FIG. 2A is a schematic diagram of image 200 displayed on the screen 130 in FIG. 1 according to some embodiments of the present disclosure. FIG. 2B is a schematic diagram illustrating a hierarchy of the plurality of layers in FIG. 2A according to some embodiments of the present disclosure. It should be understood that FIG. 2B is given for illustrating a hierarchical concept of the layers, and is not intended to limit the shape or size of each layer. The present disclosure is also not limited to the shape or size of the plurality of layers in FIG. 2A. In different embodiments, the shapes or sizes of the plurality of layers in FIG. 2A may be the same as or different from each other. Various shapes or sizes of layers are within the contemplated scope of the present case.

As shown in FIG. 2A, the screen 130 in FIG. 1 can be used to display the image 200 including at least two layers. For ease of understanding, the following embodiments are described with an example where layers 210, 220, 230, and 240 are included by the image 200. In some embodiments, the layers 210, 220, 230, and 240 can be used to display content of the aforementioned plurality of applications, system status columns, work columns, etc. In some embodiments, the contents of these layers 210, 220, 230, and 240 may be stacked or covered with each other. As shown in FIG. 2B, in the image 200, the content of an upper layer is preferentially displayed. Correspondingly, the content of a lower layer is covered and is thus not displayed. In some embodiments, the sizes of the layers 210, 220, 230, and 240 may be the same or different.

The layer 210 is a top layer. In some embodiments, the layer 210 can be used to display a menu of functions. In some embodiments, this menu contains at least one graphical button, such as graphical buttons A1 and A2. By touching the button A1, a user can input the command CMD1 to the processor 110 via the screen 130. By touching the button A2, the user can input the command CMD2 to the processor 110 via the screen 130. The layers 220 and 230 are intermediate layers that can be used to display content for audio and video applications, educational applications, or other types of applications, respectively. The layer 240 is a bottom layer. Bottom layer can be used to display the bottom interface of the system (e.g., system column, title column, status column, gadget on the desktop, etc.). The content displayed above for each layer is given for illustrative purposes, and the present disclosure is not limited to this.

FIG. 3 is a flow chart of a method 300 of freezing screen according to some embodiments of the present disclosure. For ease of understanding, method 300 of freezing screen will be described with reference to the aforementioned electronic device 100 and image 200. In some embodiments, the method 300 of freezing screen can be used for teaching applications to improve teaching convenience.

In operation S310, in response to a first command, the updating of the content of the bottom layer is stopped.

In operation S320, the content of a predetermined layer is captured. In some embodiments, the predetermined layer may be at least one layer between the top layer and the bottom layer. In some embodiments, the aforementioned predetermined layer may be at least one layer that excludes the top layer. For ease of understanding, the subsequent descriptions are given with reference to an example where the predetermined layer is the layer 230, but the present disclosure is not limited thereto.

In operation S330, the screen is controlled to display the captured content of the predetermined layer on the image.

For example, as shown in FIG. 2A, the content B1 displayed by the layer 230 can be a teaching video. When the video shows specific content and a user needs to explain the content, the user can input the command CMD1 on the screen 130 (or through other devices). Under this condition, in response to the command CMD1, the processor 110 may stop updating the content of the bottom layer (i.e., stop drawing the bottom layer) and extract the content B1 of the layer 230. In some embodiments, when the content B1 of the layer 230 is captured, the processor 110 does not capture the content of other layers at the same time. In some embodiments, the processor 110 may store the content B1 of the captured layer 230 in the memory 120. The processor 110 can control the screen 130 to display the content B1 of the captured layer 230 for the user to explain.

Referring to FIGS. 4A and 4B, FIG. 4A is a schematic diagram showing the hierarchy of the plurality of layers after operation S330 is performed, according to some embodiments of the present disclosure. FIG. 4B is a schematic diagram showing the hierarchy of the plurality of layers after operation S330 is performed according to other embodiments of the present disclosure. It should be understood that FIGS. 4A and 4B are given for illustrating the hierarchical concept of the plurality of layers, and are not intended to limit the shape or size of each layer. The shapes or sizes corresponding to the respective layers in FIGS. 4A and 4B may be the same or different from each other. As mentioned previously, layers of various shapes or sizes are within the contemplated scope of this disclosure.

In some embodiments, the processor 110 generates a floating layer 410 on the image 200 of FIG. 2A, and the floating layer 410 is used to display the content B1 of the captured layer 230. In operation S330, the processor 110 may paste the content B1 of the captured layer 230 on the floating layer 410 for display.

In some embodiments, this floating layer 410 is configured to cover all of the layers below the specified layer. For example, as shown in FIG. 4A, the specified layer may be the second layer 220, and the floating layer 410 may cover all the layers below the layer 220. Therefore, when a user views the content B1 of the floating layer 410, functions provided on the menu displayed by the top layer 210 can also be used at the same time. (e.g., highlight, annotation, switching of input sources, back to homepage, launch other applications, unfreeze, etc.). In other embodiments, as shown in FIG. 4B, the specified layer may be the topmost layer 210, and the floating layer 410 may cover all of the layers below the topmost layer 210. Therefore, the user will only see the content B1 of the floating layer 410.

Referring to FIG. 3, in operation S340, the content of the bottom layer is continuously updated. For example, after content B1 of layer 230 is captured, processor 110 continues to update the content of bottom layer. Therefore, the content of the layer 230 can be prevented from being interrupted for a long time, in order to avoid triggering an unnecessary protection mechanism in the system.

In operation S350, in response to the second instruction, the screen is controlled to stop displaying the content of the captured predetermined layer on the image. For example, after the explanation is completed, the user can input the command CMD2 on the screen 130 (or through other devices). In this case, in response to the command CMD2, the processor 110 can control the screen 130 to stop displaying the content B1 of the captured layer 230 on the image 200, in order to revert to the image 200 presented before the screenshot is taken. The processor 110 may hide the aforementioned floating layer 410 according to the command CMD2 to stop displaying the captured content B1.

The above descriptions are given with reference to examples where the predetermined layer is the layer 230, but the present disclosure is not limited thereto. Various configurations of the predetermined layer are within the contemplated scope of this case.

In some related approaches, the preset screenshot operation is to take a screenshot of the entire image on the screen. In these approaches, the captured content on the screen will have two menus corresponding to the top layer, one menu is a fixed image (cannot be controlled) generated from the screenshot operation, and one menu is a virtually controllable menu. As a result, the image will become too complicated and messy, resulting in inconvenient for users. In some related approaches, the top layer is turned off prior to taking the screenshot, and then the screenshot is taken, and finally the captured content is displayed. However, this order of execution will cause flickers on the picture. In addition, the above execution sequence requires a long processing time, and the user may sense a delay or a rewind of the image.

Compared with the above approaches, embodiments of the present disclosure stops updating the bottom layer first by operation S310, and directly captures the content of the predetermined layer by operation S320. As a result, the issues of the above related art can be improved, in order to increase the user's operation convenience and experience.

The plurality of operations of the above described method 300 of freezing screen are merely examples, and are not limited to being performed in the order of this example. The various operations under the method 300 of freezing screen may be appropriately added, replaced, omitted, or performed in a different order, without departing from the operation and scope of the embodiments of the present disclosure.

In some embodiments, method 300 of freezing screen can be implemented according to a window management rule and/or a layer management rule of a kernel of a system platform to which the electronic device 100 is applied. For example, according to the window or layer management rules of different system platforms, the layer corresponding number, size and other parameters can be set to specify the predetermined layer to be captured. In some embodiments, the above system platform can be an operating system such as Android, IOS and Linux. The above configurations are given as examples. Those skilled in the art can adjust the related commands and parameters of the window and/or layer management rules according to different system kernels and the method 300 of freezing screen.

In some embodiments, the method 300 of freezing screen can be implemented as an application on a non-transitory computer readable medium. In some embodiments, the method 300 of freezing screen can be implemented by hardware, software, firmware, or any combination of the above. For example, if speed and accuracy are the main considerations, they can be mainly implemented by hardware and/or firmware. If design flexibility is the main consideration, it can be mainly implemented by software. The above implementation manner is only an example, and the present disclosure is not limited thereto.

The electronic device 100 and method 300 of freezing screen provided in the present disclosure can efficiently capture the content of the specified layer to improve the user's operation convenience and experience.

Although the present disclosure has been disclosed in the above embodiments, it is not intended to limit the disclosure. Anyone who is familiar with the art can make various changes and refinements without departing from the spirit and scope of the disclosure. Therefore, the scope of protection of this disclosure is attached. The scope defined in the scope of application for patent application shall prevail.

What is claimed is:

1. An electronic apparatus comprising:
a screen configured to display an image, wherein the image comprises a plurality of layers;
a memory configured to store at least one computer program code; and
a processor configured to execute at least one computer program code to perform the following operations:
in response to a first instruction, control the screen to show content of a predetermined layer between a top layer and a bottom layer of the plurality of layers on the image.

2. The electronic apparatus of claim 1, wherein the processor is configured to stop updating content of the bottom layer of the plurality of layers in response to the first instruction.

3. The electronic apparatus of claim 1, wherein the processor is configured to capture the content of the predetermined layer, in order to control the screen to display the captured content of the predetermined layer on the image in response to the first instruction.

4. The electronic apparatus of claim 3, wherein the processor is further configured to paste the captured content of the predetermined layer to a floating layer of the plurality of layers, in order to display the floating layer by the screen, wherein the floating layer covers all layers which are below a specified layer of the plurality of layers.

5. The electronic apparatus of claim 4, wherein the specified layer is the top layer.

6. The electronic apparatus of claim 3, wherein the processor is configured to stop updating the content of the bottom layer of the plurality of layers in response to the first instruction, and after the content of the predetermined layer is captured, the processor is further configured to continue updating the content of the bottom layer.

7. The electronic apparatus of claim 1, wherein the processor is further configured to control the screen to stop displaying the content of the predetermined layer on the image in response to a second instruction.

8. A method of freezing a screen, comprising:
in response to a first instruction, stopping updating content of a bottom layer of a plurality of layers of an image shown on the screen; and
displaying content of a predetermined layer of the plurality of layers on the image.

9. The method of claim 8, wherein displaying the content of the predetermined layer comprising:
capturing the content of the predetermined layer, in order to display the captured content of the predetermined layer on the image.

10. The method of claim 9, further comprising:
pasting the captured content of the predetermined layer to a floating layer of the plurality of layers, in order to display the floating layer, wherein the floating layer covers all layers which are below a specified layer of the plurality of layers.

11. The method of claim 10, wherein the specified layer is a top layer.

12. The method of claim 8, further comprising:
after capturing the content of the predetermined layer, continuing updating the content of the bottom layer.

13. The method of claim 8, further comprising:
in response to a second instruction, stopping displaying the content of the predetermined layer in the image.
